(19) United States
(12) Patent Application Publication
(10) Pub. No.: US 2026/0338204 A1
(43) Pub. Date: Oct. 29, 2026

(54) ACTUATING SYSTEM COMPRISING A STABLE BALANCE POSITIONING DEVICE AND METHOD FOR POSITIONING THE SYSTEM IN A STATE OF STABLE EQUILIBRIUM

(71) Applicant: SAFRAN AEROSYSTEMS, Plaisir (FR)

(72) Inventor: Jean-Luc BERTRAND, Moissy-Cramayel (FR)

(21) Appl. No.: 19/099,043

(22) PCT Filed: Jul. 24, 2023
(86) PCT No.: PCT/FR2023/051144

§ 371 Date: Jan. 27, 2025

(30) Foreign Application Priority Data
Aug. 1, 2022 (FR) FR2207995

(51) Int. Cl. F15B 11/12; F15B 20/00

(52) U.S. Cl. CPC F15B 11/121; F15B 20/00; F15B 2211/6336; F15B 2211/6658; F15B 2211/7054; F15B 2211/8636; F15B 2211/875

(57) ABSTRACT

Disclosed is an actuating system comprising an actuator comprising a servo-cylinder, the servo-cylinder having a rod provided with a piston, the actuator having a device for setting the piston of the servo-cylinder into a predefined state of stable equilibrium, the device having a cylinder provided with a rod mechanically secured to the rod of the servo-cylinder, the cylinder comprising a piston mounted on the rod of the cylinder in such a way as to define, on either side of the piston in the cylinder, a first chamber subjected to a first pressure and a second chamber subjected to a second pressure, the first and second chambers being configured to contain a fluid, the piston of the servo-cylinder being configured to be positioned in the predefined state of stable equilibrium when the first and second pressures are equal.

### TECHNICAL FIELD

The present invention relates to an actuating system comprising an actuator comprising a servo-cylinder and a device for setting a position of stable equilibrium of a piston of the servo-cylinder.

In particular, the present invention enables the piston to be placed in a position of stable equilibrium, for example a position corresponding to a safe state of the actuating system and of an actuated system, especially in the event of the loss of control of the servo-cylinder.

Generally speaking, the present invention applies to any actuating system comprising a cylinder provided with a piston.

### PRIOR ART

In order to be able to position a piston of a hydraulic cylinder of an actuating system in a position of stable equilibrium during an incident, the actuating system generally comprises a means for bringing the piston of the cylinder in abutment, for example against one of the ends of the cylinder. The abutment means generally comprises a spring acting on a rod of the cylinder so as to place the piston in abutment in the cylinder on loss of control of the cylinder. In particular, the spring exerts a continuous force on the piston, especially against the movement of the piston. The actuating system has to compensate for the spring force, thus degrading efficiency of the actuating system.

Another solution to position the piston of the cylinder in a position of stable equilibrium is to modify the adjustment of a means for supplying fluid to the cylinder. For example, the fluid supply to the cylinder can be modified so that more fluid is supplied to a chamber of the cylinder. Thus, the piston is placed in an abutment position.

Another drawback of an abutment means as previously described is the inability to place the cylinder in an intermediate position, the intermediate position being located on the stroke of the piston between abutment positions of the cylinder.

Known solutions for setting an intermediate position of stable equilibrium involve setting up complex arrangements that are detrimental to the actuation system. In addition, these solutions do not allow a position of stable equilibrium of the cylinder in all intermediate positions.

### DISCLOSURE OF THE INVENTION

The objective of the present invention is therefore to overcome all or some of the drawbacks mentioned above and provides an actuating system comprising a servo-cylinder and a device for setting a predefined position of stable equilibrium of a piston of the servo-cylinder.

One object of the present invention is an actuating system comprising an actuator comprising a servo-cylinder, the servo-cylinder comprising a rod provided with a piston, the actuator comprising a device for setting a predefined position of stable equilibrium of the piston of the servo-cylinder, the device comprising a cylinder provided with a rod mechanically secured to the rod of the servo-cylinder, the cylinder comprising a piston mounted to the rod of the cylinder in such a way as to define, on either side of the piston in the cylinder, a first chamber subjected to a first pressure and a second chamber subjected to a second pressure, the first and second chambers being configured to contain a fluid, the piston of the servo-cylinder being configured to be positioned in the predefined position of stable equilibrium when the first and second pressures are equal.

Thus, the present invention enables the piston of the servo-cylinder to be placed in any predefined position of the stroke of said piston. The present invention enables the servo-cylinder piston to be placed in a predefined position of stable equilibrium by returning said piston to the position defined when designing the device for setting a position of stable equilibrium. The present invention also allows increased failure tolerance of the actuating system.

Advantageously, the actuating system comprises fluid supply means configured to supply the actuator with fluid.

Preferably, the servo-cylinder comprises a servo-valve, the actuator comprising an electrohydraulic selector configured to interrupt a fluid supply provided to the servo-valve in the event of undesired behaviour.

Advantageously, the cylinder comprises a first inlet for the fluid in the first chamber and a second inlet for the fluid in the second chamber.

Preferably, the cylinder comprises an outlet for the fluid placed between the first and second inlets and dimensioned so as to let through the fluid coming from the first and second inlets through the outlet when the piston of the servo-valve is in the predefined position of stable equilibrium.

In one embodiment, the cylinder comprises a first outlet for the fluid and a second outlet for the fluid placed at different locations longitudinally between the first and second inlets and dimensioned so that the first outlet lets through the fluid coming from the first inlet and the second outlet lets through the fluid coming from the second inlet when the piston of the servo-cylinder is in the predefined position of stable equilibrium.

Advantageously, the actuator comprises a position sensor for the piston of the servo-cylinder.

Preferably, the actuating system comprises a calculator configured to detect a failure of the servo-cylinder.

In one embodiment, the area of a transverse cross-section of the piston of the cylinder is less than the area of a transverse cross-section of the piston of the servo-cylinder.

One object of the present invention is also a method for setting a predefined position of stable equilibrium of a servo-cylinder of an actuating system comprising the following steps of:
Interrupting a fluid supply provided to a servo-valve of the servo-cylinder in the event of undesired behaviour;
Supplying fluid to the cylinder of the device for setting a predefined position of stable equilibrium of the piston of the servo-cylinder;
Translating the servo-cylinder to the predefined position of stable equilibrium; and
Holding the piston of the servo-cylinder in the predefined position of stable equilibrium, the first and second pressures being equal.

### BRIEF DESCRIPTION OF THE DRAWINGS

Further objectives, characteristics and advantages of the invention will appear upon reading the following description, given solely by way of a non-limiting example, and made with reference to the appended drawings in which:

FIG. 1 schematically illustrates an actuating system according to the invention;

FIG. 2 schematically illustrates a device for setting a predefined position of stable equilibrium of an actuating system according to the invention, into a position of stable equilibrium;

FIG. 3 schematically illustrates a device for setting a position of stable equilibrium of an actuating system according to the invention, the piston of the device leaving the first and second outlets free;

FIG. 4 schematically illustrates a device for setting a position of stable equilibrium of an actuating system according to the invention, the piston of the device obstructing the first and second outlets; and

FIG. 5 schematically illustrates a method for setting a servo-cylinder of an actuating system according to the invention into a predefined position of stable equilibrium.

### DETAILED DISCLOSURE OF AT LEAST ONE EMBODIMENT

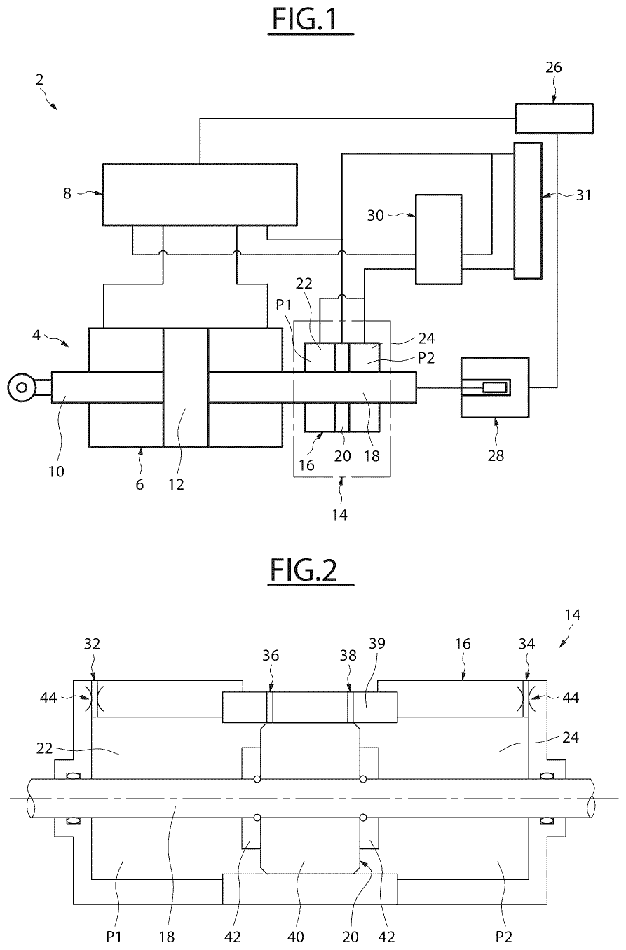

An actuating system 2 comprising an actuator comprising a servo-cylinder 4 comprising a servo-controlled cylinder 6 equipped, for example, with a servo-valve 8 has been schematically represented in FIG. 1. Alternatively, the servo-controlled cylinder 6 comprises, for example, a proportional control distributor.

The servo-controlled cylinder 6 comprises a rod 10 provided with a piston 12 moving between two abutment positions. The piston 12 of the servo-cylinder 4 defines two chambers, each supplied by the servo-valve 8. The servo-cylinder 4 advantageously comprises low-friction seals to provide sealing of the two chambers when the piston 12 of the servo-cylinder 4 moves.

The servo-cylinder 4 of the actuating system 2 enables, for example, an aeronautical or automotive system to be actuated. The actuating system 2 described herein is particularly useful for single-engine aircraft architectures.

The actuator further comprises a device 14 for setting a predefined position of stable equilibrium. The device 14 comprises a cylinder 16 provided with a rod 18 mechanically secured to the rod 10 of the servo-cylinder 4. The rod 18 of the cylinder 16 and the rod 10 of the servo-cylinder 4 are, for example, welded to each other at their ends or are manufactured as a single unit. Alternatively, the rod 18 of the cylinder 16 is, for example, coupled to the rod 10 of the servo-cylinder 4 by a dismountable coupling element. The coupling element enables, for example, positional errors between the cylinder 16 and the servo-cylinder 4 to be corrected. Furthermore, when the rod 18 of the cylinder 16 moves, the rod 10 of servo-cylinder 4 moves and vice versa.

The cylinder 16 comprises a piston 20 mounted to the rod 18 of the cylinder 16 in such a way as to define, on either side of the piston 20 in the cylinder 16, a first chamber 22 subjected to a first pressure P1 and a second chamber 24 subjected to a second pressure P2. Advantageously, the piston 20 moves in the cylinder 16 with a stroke substantially equal to the stroke of the piston 12 in the servo-controlled cylinder 6 to within a margin allowing mechanical tolerance between the cylinder 16 and the servo-cylinder 4. Furthermore, when the piston 20 of the cylinder 16 moves, the piston 12 of the servo-cylinder 4 moves in the same way and vice versa.

The first and second chambers 22, 24 are configured to contain a fluid, for example oil.

Advantageously, the actuating system 2 comprises a calculator 26 electronically connected to the servo-valve 8. The calculator 26 controls, for example, the servo-valve 8 supplying the servo-controlled cylinder 6 with fluid, for example oil, so as to control the position of the piston 12 of the servo-cylinder 4. For example, the calculator 26 sends an order in the form of an electrical signal to the servo-valve 8, the servo-valve 8 supplying the servo-controlled cylinder 6 with fluid as a function of the order from the calculator so as to position the cylinder in a desired position.

Advantageously, the servo-controlled cylinder 6 and the first and second chambers 22, 24 are supplied with the same fluid. Advantageously, the servo-valve 8 is mounted directly to the servo-controlled cylinder 6 in order to have increased responsiveness of the servo-cylinder 4.

Optionally, the actuator comprises a position sensor 28 for the piston 12 of the servo-cylinder 4 electronically connected to the calculator 26. The calculator 26 analyses the position of the piston 12 of the servo-cylinder 4 measured by the position sensor 28 and detects whether the position of the piston 12 of the servo-cylinder 4 is the position controlled by the calculator 26. In one embodiment, the position sensor 28 is coupled to the rod 10 of the servo-cylinder 4. In another embodiment, the position sensor 28 is coupled to the rod 18 of the cylinder 16.

In one embodiment, the servo-valve 8 comprises a flow rate sensor (not represented) enabling the flow rate of fluid supplied by the servo-valve 8 to the servo-controlled cylinder 6 to be checked. The flow rate sensor is electronically connected to the calculator 26. The calculator 26 analyses the flow rate of fluid measured by the flow rate sensor and detects whether the flow rate of the fluid supplied by the servo-valve 8 is the flow rate controlled by the calculator 26.

The calculator 26 is thus configured to detect a failure of the actuating system 2, the failure corresponding, for example, to an active failure, that is, an abnormal supply to the servo-valve 8, or to a passive failure, that is, an absence of fluid distribution by the servo-valve 8.

Advantageously, the actuator comprises an electrohydraulic selector 30 electronically connected to the calculator 26, and fluidically connected to the servo-valve 8 and to the cylinder 16 of the device 14 for setting a predefined position of stable equilibrium.

Advantageously, the actuating system 2 comprises high-and low-pressure fluid supply means 31 fluidically connected to the electrohydraulic selector 30, to the servo-valve 8 and to the device 14 for setting a position of equilibrium. Advantageously, the electrohydraulic selector 30 is connected to a hydraulic circuit connecting the supply means 31 to the servo-valve 8 so that fluid circulating between the supply means 31 and the servo-valve 8 passes through the electrohydraulic selector 30. Advantageously, the electrohydraulic selector 30 is connected to a hydraulic circuit connecting the supply means 31 to the cylinder 16 of the device 14 so that fluid circulating between the supply means 31 and the cylinder 16 of the device 14 passes through the electrohydraulic selector 30. Preferably, the servo-valve 8 is permanently connected to the low-pressure fluid supply means 31 by a hydraulic line. Preferably, the cylinder 16 of the device 14 is permanently connected to the low-pressure fluid supply means 31 by a hydraulic line.

Supplying high-pressure fluid comprises, for example, injecting a fluid under a pressure close to 10 bar, or under a pressure of between 10 and 350 bar, for example under a pressure of 210 bar, into the lines of the actuating system 2. Supplying low-pressure fluid comprises, for example, exhausting a fluid circulating in the actuating system 2.

The electrohydraulic selector 30 comprises, for example, a distributor with four circulation ports and two possible positions of the distributor. The four circulation ports comprise, for example, a high-pressure fluid intake port, an exhaust outlet port, a first circulation port and a second circulation port. The first position of the distributor corresponds, for example, to the circulation of a high-pressure fluid from the high-pressure fluid intake port to the first circulation port and to the exhaust of a fluid from the second circulation port to the exhaust outlet port. The second position of the distributor corresponds, for example, to the circulation of a high-pressure fluid from the high-pressure fluid intake port to the second circulation port and to the exhaust of a fluid from the first circulation port to the exhaust outlet port.

Furthermore, the electrohydraulic selector 30 is configured to switch between several operating modes. For example, in a first operating mode the electrohydraulic selector 30 supplies the servo-valve 8 with high-pressure fluid coming from the supply means 31 and supplies the cylinder 16 of the device 14 with low-pressure fluid coming from the supply means 31. For example, in a second operating mode, the electrohydraulic selector 30 supplies the servo-valve 8 with low-pressure fluid coming from the supply means 31 and supplies the cylinder 16 of the device 14 with high-pressure fluid coming from the supply means 31.

During normal operation of the actuating system 2, for example when the calculator 26 does not detect a failure, the electrohydraulic selector 30 connects the servo-valve 8 to the supply means 31 so as to supply the servo-valve 8 with high-pressure fluid and connects the cylinder 16 of the device 14 to the supply means 31 so as to discharge low-pressure fluid from the cylinder 16 of the device 14.

During abnormal operation of the actuating system 2, for example when the calculator 26 detects a failure comprising an incorrect position of the cylinder 6 due to an undesired fluid supply provided by the servo-valve 8 or when the calculator 26 detects an undesired behaviour of the servo-valve 8, the electrohydraulic selector 30 connects the servo-valve 8 to the supply means 31 so as to discharge low-pressure fluid from the servo-valve 8 and connects the cylinder 16 of the device 14 to the supply means 31 so as to supply the cylinder 16 of the device 14 with high-pressure fluid. This situation interrupts the undesired fluid supply from the servo-valve 8 and results in setting a position of stable equilibrium the servo-controlled cylinder 6.

The position of stable equilibrium corresponds, for example, to a rest position of the actuating system 2 allowing the actuating system 2 to be made available for new use, to a collection position of the actuating system 2 or to a maintenance position allowing simplified access to the actuating system 2, especially for repair of the actuating system 2. A device 14 for setting a position of stable equilibrium according to the invention has been schematically represented in FIG. 2. The device 14 represented is in the predefined position of stable equilibrium.

The cylinder 16 of the device 14 comprises a first inlet 32 for the high-pressure fluid in the first chamber 22 and a second inlet 34 for the high-pressure fluid in the second chamber 24. Following detection of a failure, the first and second inlets 32, 34 are supplied with high-pressure fluid by the electrohydraulic selector 30.

The cylinder 16 of the device 14 also comprises a first outlet 36 for the low-pressure fluid and a second outlet 38 for the low-pressure fluid placed at different positions longitudinally between the first and second inlets 32, 34. The first and second outlets 36, 38 are provided into an element 39 constituting the wall of the cylinder 16 of the device 14. The longitudinal position of the element 39 is advantageously selected when designing the device 14 so as to be able to construct actuating systems 2 whose predefined position of stable equilibrium can be adjusted from one manufacture to another. Preferably, the first and second outlets 36, 38 are connected to the low-pressure fluid supply means 31.

When the first and second inlets 32, 34 are supplied with high-pressure fluid and the first and second outlets 36, 38 are connected to the low-pressure fluid supply means 31, the piston 20 of the cylinder 16 is moved by the difference between the first and second pressures P1, P2 to place itself in the position of stable equilibrium. Furthermore, the first and second pressures P1 and P2 exert a force on the piston 20 of the cylinder 16. This force moves the rod 10 of the servo-cylinder 4 mechanically secured to the rod 18 of the cylinder 16. More particularly, the first and second pressures P1 and P2 will vary when the piston 20 of the cylinder 16 moves until they are equal and therefore each exert an equal force on the piston 20 of the cylinder 16 when the servo-cylinder 4 is placed in its position of stable equilibrium.

The cross-section of the cylinder 16 of the device 14 is advantageously configured to provide a force sufficient to place the servo-controlled cylinder 6 in the position of stable equilibrium. A larger cross-section of the cylinder 16 of the device 14 makes it possible to overcome greater opposing forces, especially from the servo-controlled cylinder 6.

The present invention further enables a mechanical force to be applied from a hydraulic modulation.

In another embodiment, the actuating system 2 does not comprise an electrohydraulic selector 30. The cylinder 16 of the device 14 and the servo-controlled cylinder 6 are then both connected to the high-pressure fluid supply means 31, the cylinder 16 of the device 14 continuously exerting a force on the servo-controlled cylinder 6 so as to return it to its position of stable equilibrium. Advantageously, the area of a transverse cross-section of the piston 20 of the cylinder 16 is less than the area of a transverse cross-section of the piston 12 of the servo-cylinder 4 so that the cylinder 16 of the device 14 exerts a low parasitic force on the servo-controlled cylinder 6 during its normal operation. During a passive failure of the servo-cylinder 4, the cylinder 16 of the device 14 places the servo-controlled cylinder 6 in its position of stable equilibrium. Advantageously, during an active failure, the supply to the servo-cylinder 4 is cut off, for example manually, and the device 14 places the servo-controlled cylinder 6 in its position of stable equilibrium.

The piston 20 of the device 14 comprises a portion 40 of substantially cylindrical shape, with a diameter substantially equal to the diameter of the internal transverse cross-section of the piston 20 of the device 14 and with a height substantially equal to the longitudinal distance between the first and second outlets 36 and 38. In the position of stable equilibrium, the first and second outlets 36, 38 are located partially on either side of the piston 20 of the device 14. Advantageously, the angles of the portion 40 of the piston 20 are bevelled so that the fluid circulates from the first inlet 32 to the first outlet 36 and from the second inlet 34 to the second outlet 38 when the cylinder 16 of the device 14 is in the position of stable equilibrium. In another embodiment, the angles of the portion 40 of the piston 20 have sharp edges or any other transitional shape.

The piston 20 of the device 14 advantageously comprises low-friction seals in order to provide sealing of the first and second chambers 22, 24 when the piston 20 of the device 14 moves.

The piston 20 of device 14 comprises two stops 42 on either side of the portion 40. Advantageously, the first inlet 32 is located as close as possible to the abutment position of the piston 20 on the first chamber 22 side, the corresponding stop 42 being dimensioned so that the high-pressure fluid can enter the first chamber 22 via the first inlet 32 when the piston 20 of the device 14 is in the abutment position. Advantageously, the second inlet 34 is located as close as possible to the abutment position of the piston 20 on the second chamber 24 side, the corresponding stop 42 being dimensioned so that the high-pressure fluid can enter into the second chamber 24 via the second inlet 34 when the piston 20 of the device 14 is in the abutment position.

In one embodiment, the first and second inlets 32, 34 are provided with adjustable restrictions 44 disposed in an exhaust line of the first and second inlets 32, 34. When the actuating system 2 is in a position of stable equilibrium, there is an equilibrium of forces applied to the piston 20 of the device 14. The adjustable restrictions 44 can be used, for example, to modify the speed for setting a position of stable equilibrium of the actuating system 2. The value of the first and second pressures P1 and P2 and/or the recentring speed and/or the fluid circulation from the first and second inlets 32, 34 to the first and second outlets 36, 38 is for example determined by the dimensions of the restrictions 44 and by the overlaps of the portion 40 of the piston 20 with the first and second outlets 36 and 38. The recentring speed also depends on the means implemented to connect the uses of the servo-valve 8 in the event of failure, which are not described because they are known in the state of the art.

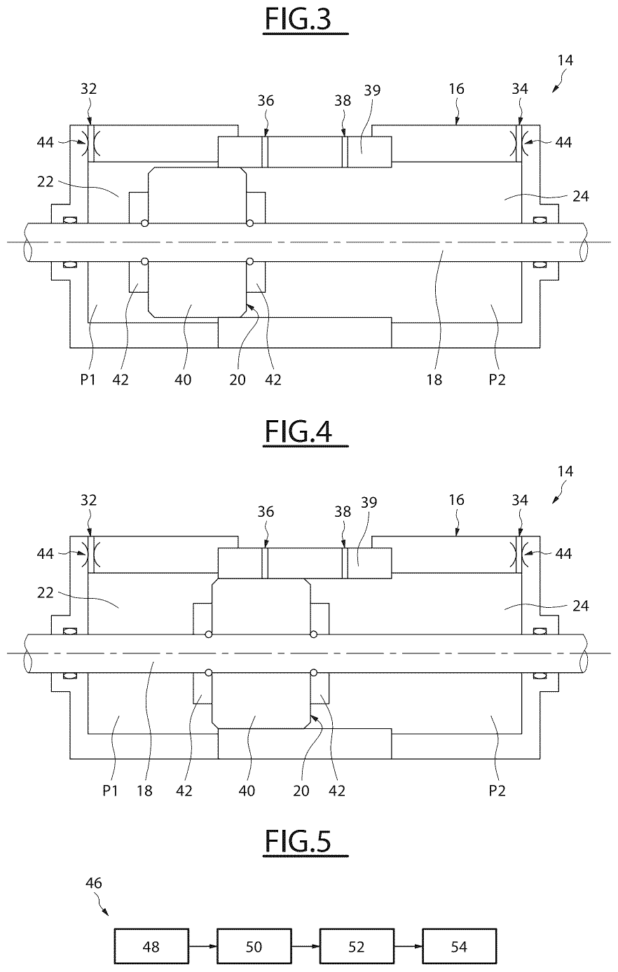

A device 14 for setting a position of stable equilibrium according to the invention has been schematically represented in FIG. 3. The device 14 is represented in a position such that the volume of the first chamber 22 is less than the volume of the second chamber 24. When a failure of the servo-cylinder 4 is detected, the electrohydraulic selector 30 switches to change the supply mode and cuts off the high-pressure fluid supply to the servo-valve 8 and therefore to the servo-controlled cylinder 6. The electrohydraulic selector 30 then supplies the first and second inlets 32, 34 with high-pressure fluid, for example simultaneously.

Following detection of the failure, the first chamber 22 is supplied with high-pressure fluid which cannot be discharged through the first and second outlets 36, 38 located in the second chamber 24. The pressure P1 in the first chamber 22 then increases and is greater than the pressure P2 in the second chamber 24. The pressure in the first chamber 22 is, for example, equal to the pressure of the fluid injected under high pressure. The pressure in the second chamber 24 is, for example, equal to the pressure of the fluid in a low-pressure circuit of the supply means 31. In one embodiment, the fluid in the first chamber 22 flows at a very low flow rate between the element 39 and the portion 40 of the piston 20 of the device 14 so as to control the recentring speed, the pressure in the first chamber 22 not increasing too quickly. The force exerted by the first and second pressures P1, P2 on the piston 20 of the device 14 tends to move it towards its position of stable equilibrium.

Preferably, this very low flow between the element 39 and the portion 40 of the piston 20 of the device is taken into account when designing the actuating system 2. The value of the first and second pressures P1 and P2 and/or the recentring speed and/or the circulation of the fluid from the first and second inlets 32, 34 to the first and second outlets 36, 38 is advantageously determined by the dimensions of the restrictions 44, by the overlaps of the portion 40 of the piston 20 with the first and second outlets 36 and 38 and by the value of this flow.

A device 14 for setting a position of stable equilibrium according to the invention has been schematically represented in FIG. 4. The device 14 is represented in a position intermediate to the situations of FIGS. 2 and 3. The piston 20 of the device 14 overlaps the first outlet 36, as the fluid in the first chamber 22 is still unable to reach an outlet 36, 38 for the fluid. The pressure P1 in the first chamber 22 is still higher than the pressure P2 in the second chamber 24. The piston 20 of the device 14 therefore continues its movement towards the position of stable equilibrium illustrated in FIG. 2.

The opposite situation, when the device 14 is in a position such that the volume of the first chamber 22 is greater than the volume of the second chamber 24, is understood by symmetry in a similar way.

The device 14 represented in FIG. 2 has a transverse axis of symmetry, however other structures are possible for the cylinder 16 of the device 14. The volumes of the first and second chambers 22, 24 may, for example, be different when the piston 20 of the device 14 is in the central position of its stroke.

The first and second outlets 36, 38 are for example located on either side of the piston 20 of the device 14 positioned in a non-central position of its stroke so as to define a position of stable equilibrium of the servo-controlled cylinder 6 different from the central position of its stroke. The choice of the intermediate position of stable equilibrium is free by design, it is especially predefined by modifying the overlap of the piston 20 of the device 14 with the first and second outlets 36, 38.

In another embodiment, the first and second outlets 36, 38 are fluidly connected, for example by a slot provided into a wall of the piston 20 of the device 14 so that the first and second outlets 36, 38 fluidly communicate and form a single outlet.

FIG. 5 also represents the steps of a method 46 for setting a predefined position of stable equilibrium of a servo-cylinder 4 of an actuating system 2.

Firstly, a step 48 of interrupting an undesired fluid supply provided by a servo-valve 8 of the servo-cylinder 4, is performed. The interruption step 48 occurs, for example, after detection of a failure by the calculator 26. Before the failure, the electrohydraulic selector 30 connects, for example, the means for supplying 31 high-pressure fluid to the servo-valve 8 and connects, for example, the device 14 to the low-pressure fluid supply means 31.

And then a step 50 of supplying fluid to the cylinder 16 of the device 14 for setting a predefined position of stable equilibrium of the piston 12 of the servo-cylinder 4, is performed. During the supply step 50, the electrohydraulic selector 30 connects, for example, the servo-valve 8 to the low-pressure fluid supply means 31 and connects, for example, the device 14 to the high-pressure fluid supply means 31. Advantageously, the steps 48 and 50 are implemented simultaneously, especially by switching the electrohydraulic selector 30 between two operating modes.

Next, a step 52 of translating the servo-cylinder 4 to the predefined position of stable equilibrium, is performed. Advantageously, the step 52 is performed at the same time as the step 50. By simultaneous action of steps 50 and 52, it is meant that the steps 50 and 52 take place at the same time, or are offset in time by a negligible amount.

Step 52 comprises translating the piston 20 of the cylinder 16 to the predefined position of stable equilibrium. The rod 10 of the servo-cylinder 4 mechanically secured to the rod 18 of the cylinder 16 is also translated to the position of stable equilibrium during the step 52 so as to position the servo-cylinder 4 in the predefined position of stable equilibrium. Finally, a step 54 of holding the piston 12 of the servo-cylinder 4 in the predefined position of stable equilibrium, is performed. During the step 54, the first and second pressures P1, P2 are equal. When the piston 12 of the servo-cylinder 4 moves away from the position of stable equilibrium, capping of the first and second outlets 36, 38 is modified. Thus, the first and second pressures P1, P2 are modified and tend to return the piston 12 of the servo-cylinder 4 to the position of stable equilibrium. The pressure of the chamber whose volume has decreased increases and exerts, on the piston 12 of the servo-cylinder 4, a force greater than the force exerted by the pressure of the other chamber on the piston 12 of the servo-cylinder 4, the greater force returning the piston 12 of the servo-cylinder 4 to the position of stable equilibrium in which the first and second pressures P1, P2 are equal.

1. An actuating system comprising an actuator comprising a servo-cylinder, the servo-cylinder comprising a rod provided with a piston, the actuator comprising a device for setting a predefined position of stable equilibrium of the piston of the servo-cylinder, the device comprising a cylinder provided with a rod mechanically secured to the rod of the servo-cylinder, the cylinder comprising a piston mounted to the rod of the cylinder in such a way as to define, on either side of the piston in the cylinder, a first chamber subjected to a first pressure and a second chamber subjected to a second pressure, the first and second chambers being configured to contain a fluid, the piston of the servo-cylinder being configured to be positioned in the predefined position of stable equilibrium when the first and second pressures are equal, characterised in that:
the cylinder comprises a first inlet for the fluid in the first chamber and a second inlet for the fluid in the second chamber,
the cylinder comprising a first outlet for the fluid and a second outlet for the fluid placed at different locations longitudinally between the first and second inlets and dimensioned so that the first outlet lets through the fluid coming from the first inlet and the second outlet lets through the fluid coming from the second inlet when the piston of the servo-cylinder is in the predefined position of stable equilibrium,
the servo-cylinder comprises a servo-controlled cylinder equipped with a servo-valve,
the actuating system comprises a calculator configured to detect a failure of the servo-cylinder,
the actuator comprises an electrohydraulic selector electronically connected to the calculator, and fluidically connected to the servo-valve and to the cylinder of the device for setting a predefined position of stable equilibrium.
the actuating system comprises high-and low-pressure fluid supply means fluidically connected to the electrohydraulic selector, to the servo-valve and to the device for setting a position of equilibrium,
the electrohydraulic selector is configured to switch between several operating modes,
in a first operating mode the electrohydraulic selector supplies the servo-valve with high-pressure fluid coming from the supply means and supplies the cylinder of the device with low-pressure fluid coming from the supply means, and
in a second operating mode the electrohydraulic selector supplies the servo-valve with low-pressure fluid coming from the supply means and supplies the cylinder of the device with high-pressure fluid coming from the supply means.

2. The system according to claim 1, wherein the electrohydraulic selector is configured to interrupt a fluid supply provided to the servo-valve in the event of undesired behaviour.

3. (canceled)

4. (canceled)

5. The system according to claim 1, wherein the actuator comprises a position sensor for the piston of the servo-cylinder.

6. (canceled)

7. The system according to claim 1, wherein the area of a transverse cross-section of the piston of the cylinder is less than the area of a transverse cross-section of the piston of the servo-cylinder.

8. A method for setting a predefined position of stable equilibrium of a servo-cylinder of an actuating system according to claim 1, the method comprising the following steps of:
Interrupting a fluid supply provided to a servo-valve of the servo-cylinder in the event of undesired behaviour;
Supplying fluid to the cylinder of the device for setting a predefined position of stable equilibrium of the piston of the servo-cylinder;
Translating the servo-cylinder to the predefined position of stable equilibrium; and
Holding the piston of the servo-cylinder in the predefined position of stable equilibrium, the first and second pressures being equal.
